(19) United States
(12) Patent Application Publication
(10) Pub. No.: US 2014/0351874 A1
(43) Pub. Date: Nov. 27, 2014

(54) METHOD AND APPARATUS FOR TRANSMITTING MEDIA DATA FOR MMT SYSTEM, AND APPARATUS AND METHOD FOR RECEIVING MEDIA DATA

(71) Applicant: Electronics and Telecommunications Research Institute, Daejeon (KR)

(72) Inventors: Jeong Ju Yoo, Daejeon-si (KR); Chang Ki Kim, Daejeon-si (KR); Tae Jung Kim, Cheongju-si (KR); Young Ho Jeong, Daejeon-si (KR); Jin Woo Hong, Daejeon-si (KR); Kwang Deok Seo, Wonju-si (KR); Hong-Rae Lee, Wonju-si (KR)

(21) Appl. No.: 14/345,074

(22) PCT Filed: Sep. 21, 2012
(86) PCT No.: PCT/KR2012/007618

§ 371 Date: Mar. 14, 2014

(30) Foreign Application Priority Data
Sep. 23, 2011 (KR) 10-2011-0096491
Sep. 21, 2012 (KR) 10-2012-0105347

(51) Int. Cl. H04N 21/6437; H04N 21/61; H04N 21/442; H04N 21/24; H04N 21/236; H04N 21/434

(52) U.S. Cl. CPC H04N 21/6437; H04N 21/23605; H04N 21/23602; H04N 21/4343; H04N 21/4342; H04N 21/44209; H04N 21/2402; H04N 21/6125
USPC 725/116; 725/131

(57) ABSTRACT

Provided are a method and apparatus for transmitting and receiving media data, which can provide D-layer timing information, which is transmitted from a media transmission service based on an MMT system and required for timely synchronization playout time of the media and media. The apparatus for transmitting the media data comprises a packetizer for generating a delivery layer packet (D-layer packet), which packetizes encapsulation layer data (E-layer data) to include timing information, wherein the timing information comprises sampling time information and transmission process delay information.

### BACKGROUND OF THE INVENTION

1. Field of the Invention

The present invention relates to an apparatus and a method for transmitting and receiving media data, and more particularly, to timing information of a delivery layer (D-layer) required to transmit and receive the media data for an MPEG media transport (MMT) system.

2. Related Art

An MPEG media transport (MMT) is a new standard technology that starts to be developed by an MPEG systems sub-working group. The existing MPEG-2 system has standardized an MPEG-2 transport stream (TS) technology as a standard for functions of packetization, synchronization, multiplexing, and the like, required to transmit AV contents in a broadcasting network, which has been currently widely used. However, the MPEG-2 TS is inefficient in the packet delivery environment in which the network is based on Internet protocol (IP). Therefore, the ISO MPEG has recognized a necessity of a new media transmission standard in consideration of new media transmission environment and media transmission environment expected in the future and has started MMT standardization.

FIG. 1 is a conceptual diagram showing a hierarchical structure of an MMT system and shows functional architecture. The hierarchical structure is configured to largely include three layers such as an encapsulation layer (E-layer), a delivery layer (D-layer), a signaling layer (S-layer), and the like. The timing information devised in the present invention is a function that is required in the D-layer. One of the important functions of the D-layer of the MMT transmits the important timing information that is generated during the D-layer packetization process prepared for the generation and transmission of the MMT packet at a sender to a receiving terminal. The transmitted timing information may be used together with the E-layer timing information at a receiver. This is to play media while maintaining synchronization between the media. Therefore, the present invention may include the D-layer timing information for providing accurate temporal synchronization between the media in an MMT system based media service and a synchronization method of using the timing information.

As the related art for transmitting the important time information that is generated during a media transmission process similar to a timing model of the MMT, there are a DTS that is adopted in an MPEG-2 system technology, a PTS based timing model, and a timing model based on RTP timestamp and NTP timestamp information that is provided in an RTP protocol.

Describing in more detail, the timing model for transmitting media that has been developed in the related art has largely two types. First, the MPEG-2 system technology and second, a method for using a combination of a real-time transport protocol (RTP) and an RTP control protocol (RTCP) are present. In the MPEG-2 system, presentation time stamp (PTS) and decoding time stamp (DTS) timing information is used as the timing information for configuring the timing model so as to determine media playout time. In the case of the method for compositely using the RTP and the RTCP, the RTP timestamp information recorded in the RTP and the network time protocol (NTP) timestamp recorded in an RTCP sender report (SR) may be used simultaneously.

The MPEG-2 system technology proposes the timing model for transmitting the compressed media through a stable transmission network such as a broadcasting network. The MPEG-2 system is generally a standard developed for the purpose of digital broadcasting services, such that the transmitted MPEG-2 transport stream (TS) packets are transmitted to a receiver through the broadcasting network that is a circuit switched network in which quality of a channel is relatively stable. Therefore, packet delay time of the MPEG-2 TS packets experienced in a transmission channel is relatively short and constant and the timing model for sequentially processing TS packets arriving at a receiver is relatively stably operated. However, in the case of the IP network rather than the broadcasting network, an interval of arrival delay time experienced by the transmitted TS packets is very irregular and therefore, it is difficult to stably maintain the timing model adopted by the MPEG-2 system technology.

In the case of the RTP/RTCP based timing model, the RTP timestamp recorded in the header of the RTP packet represents an internal temporal sequence relationship of the specific media stream. Therefore, in order to provide the synchronization between different media streams, there is a need to transmit the timing information corresponding to wall-clock. The timing information transmitted to the terminal for achieving the above object is the NTP timestamp. The NTP timestamp is transmitted by being carried on the RTCP sender report (SR) packet and is repeatedly transmitted while having a predetermined period. The RTCP SR packet is a stream transported separately from the RTP stream for media transmission and as a result, a traffic burden for the network is increased and an operation of a transmitting and receiving system is complicated due to the increase in a UDP port and the number of streams that need to be managed by a server/terminal.

Therefore, in the D-layer of the MMT technology that has been newly standardized so as to solve the problems of the methods, a need exists for the timing model capable of effectively transmitting the important time information generated during the D-layer packetization process prepared for MMT packet transmission to the receiving terminal.

### SUMMARY OF THE INVENTION

The present invention may include the simple timing model capable of effectively transmitting the important time information generated during the D-layer packetization process prepared for the MMT packet transmission in the D-layer of the MMT technology to the receiving terminal and the timing information required to operate the timing model. Therefore, it is possible to implement the accurate temporal synchronization between the transmitted media in the MMT system based media transmission service by devising the timing information to be provided from the D-layer of the MMT system.

The present invention provides an apparatus and a method for transmitting media data capable of providing playout time of transmitted media in an MMT system based media transport service and D-layer timing information required for temporal synchronization between the media.

The present invention also provides an apparatus and a method for receiving media data capable of providing playout time of transmitted media in an MMT system based media transport service and D-layer timing information required for temporal synchronization between the media.

In an aspect, an apparatus for transmitting media data includes: a packetizer packetizing an encapsulation layer data (E-layer data) to generate a delivery layer packet (D-layer packet) including timing information, the timing information includes sampling time information and sender processing delay. The apparatus may further include: an encoder encoding the media data to generate a media stream; a buffer storing the encoded media stream; an encapsulator encapsulating the encoded media stream to generate the S-layer data; and a transmitter transmitting the packetized D-layer packet. The sampling time information may be a network time protocol (NTP) time stamp format and includes a seconds part and a seconds fraction part, and the seconds part may have a size corresponding to any one of 32 bits and 16 bits. The sender processing delay may include delay time information up to time when the D-layer packet is generated and the transmission thereof starts after the sampling time according to the sampling time information.

In another aspect, an apparatus for receiving media data includes: a depacketizer depacketizing a delivery layer packet (D-layer packet) to generate an encapsulation layer data (E-layer data) and extract timing information, the timing information includes sampling time information and sender processing delay. The apparatus for receiving media data may further include: a receiver receiving a delivery layer packet (D-layer packet); a decapsulator decapsulating the E-layer data to generate an encoded media stream; a buffer storing the encoded media stream; a decoder decoding the encoded media stream; and a rendering buffer realigning the decoded media data for display. The apparatus for receiving media data may further include: a controller determining delivery time representing time when the apparatus for transmitting media data generates a D-layer packet based on the sampling time information and the sender processing delay and starts to transmit the generated D-layer packet. The controller may measure arrival time representing the time when the D-layer packet arrives at the apparatus for receiving media data and additionally determines transmission delay based on the arrival time and the transmission time. The controller may determine receiver processing delay based on the sender processing delay and the receiver processing delay included in the sender processing delay so as to constantly maintain a total of delay time. Meanwhile, the controller may use the sampling time information and the sender processing delay so as to adjust the synchronization of the media data received from different apparatuses for transmitting media data.

In still another aspect, a method for transmitting media data includes: packetizing an encapsulation layer data (E-layer data) to generate a delivery layer packet (D-layer packet) including timing information, wherein the timing information includes sampling time information and sender processing delay. The method for transmitting media data may further include encoding the media data to generate a media stream; storing the encoded media stream; encapsulating the encoded media stream to generate the E-layer data; and transmitting the packetized D-layer packet. The sampling time information may be a network time protocol (NTP) time stamp format and may include a seconds part and a seconds fraction part, and the seconds part may have a size corresponding to any one of 32 bits and 16 bits. The sender processing delay may include delay time information up to time when the D-layer packet is generated and the transmission thereof starts after sampling time according to the sampling time information.

In still yet another aspect, a method for receiving media data, includes: depacketizing a delivery layer packet (D-layer packet) to generate an encapsulation layer data (E-layer data) and extract timing information, wherein the timing information includes sampling time information and sender processing delay. The method for receiving media data may further include: receiving the delivery layer packet (D-layer packet); decapsulating the E-layer data to generate an encoded media stream; storing the encoded media stream; decoding the encoded media stream; and realigning the decoded media data for display. The method for receiving media data may further include: determining delivery time representing time when the apparatus for transmitting media data generates a D-layer packet based on the sampling time information and the sender processing delay and starts to transmit the generated D-layer packet. The method for receiving media data may further include: measuring arrival time representing the time when the D-layer packet arrives at the apparatus for receiving media data and additionally determining transmission delay based on the arrival time and the transmission time. The method for receiving media data may further include: determining receiver processing delay based on the sender processing delay and the receiver processing delay included in the sender processing delay so as to constantly maintain a total of delay time. Meanwhile, the sampling time information and the sender processing delay may be used to implement the synchronization of the media data received from different apparatuses for transmitting media data.

### BRIEF DESCRIPTION OF THE DRAWINGS

FIG. 1 is a conceptual diagram showing an MMT hierarchical structure.

FIG. 2 is a diagrams showing basic timing information that is recorded in a D-layer header of an MMT.

FIG. 3 is a block diagram showing a configuration of an apparatus for transmitting media data according to an exemplary embodiment of the present invention.

FIG. 4 is a diagram showing main time information that needs to be considered to maintain accurate synchronization between media in the apparatus for transmitting media data.

FIG. 5 is a diagram showing a method for selecting a length of a seconds part of sampling timing information of FIG. 2.

FIG. 6 is a block diagram showing a configuration of an apparatus for receiving media data according to an exemplary embodiment of the present invention.

FIG. 7 is a diagram showing main time information that needs to be considered to maintain accurate synchronization between media in the apparatus for receiving media data.

FIG. 8 is a diagram showing temporal correlation between the timing information used in the exemplary embodiment of the present invention.

FIG. 9 is a flow chart of a method for transmitting media data according to an exemplary embodiment of the present invention.

FIG. 10 is a flow chart of a method for receiving media data according to an exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

MMT Hierarchical Structure

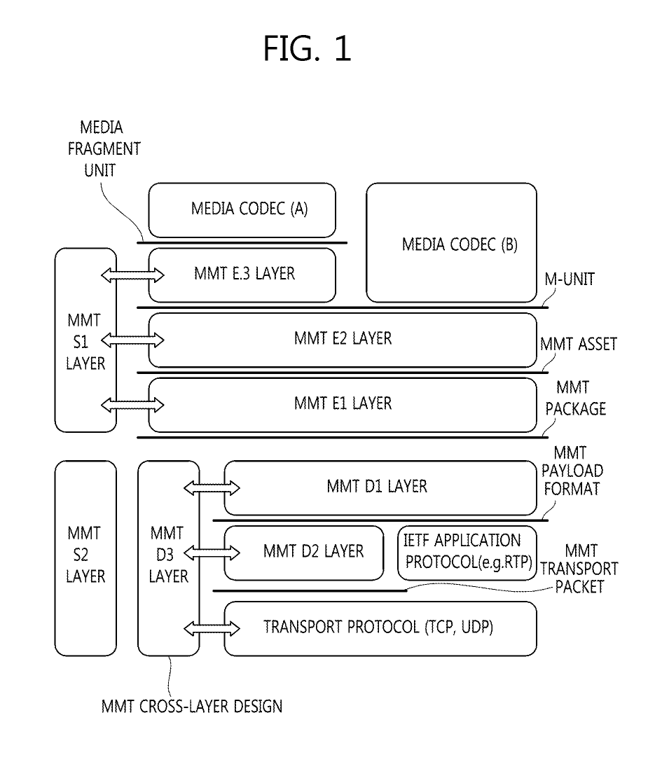

FIG. 1 is a conceptual diagram showing an MMT hierarchical structure.

Referring to FIG. 1, an MMT layer includes functional areas of an encapsulation layer, a delivery layer, and an S layer. The MMT layer is operated on a transport layer.

The encapsulation layer (E-layer) plays a role of, for example, packetization, fragmentation, synchronization, multiplexing, and the like, of transported media.

The E-layer may be configured of an MMT E.1 layer, an MMT E.2 layer, and an MMT E.3 layer, as shown in FIG. 1.

The E.3 layer encapsulates a media fragment unit (MFU) provided from a media codec A layer to generate an M-unit.

The MFU may have a format independent from any specific codec so as to carry a data unit that may be independently consumed in a media decoder. The MFU may be, for example, a picture or a slice of video.

The M-unit may be configured of one or a plurality of MFUs and may have a format independent from a specific codec so as to carry one or a plurality of access units.

The E.2 layer encapsulates the M-unit generated in the E.3 layer to generate an MMT asset.

The MMT asset, which is data entity configured of one or the plurality of M-units from a single data source, is a data unit in which composition information and transport characteristics are defined. The MMT asset may correspond to packetized elementary streams (PES) and may correspond to, for example, video, audio, program information, MPEG-U widget, JPEG image, MPEG 4 file format, MPEG transport stream (M2TS), and the like.

The E.1 layer encapsulates the MMT asset generated in the E.2 layer to generate the MMT package.

The MMT package may be configured of one or the plurality of MMT assets, together with additional information such as composition information and transport characteristics. The composition information includes information on the relationship between the MMT assets and when one content is configured of the plurality of MMT packages, may further include the information showing the relationship between the plurality of MMT packages. The transport characteristics may include transport characteristic information required to determine delivery conditions of the MMT asset or the MMT packet, for example, a traffic descriptor parameter and QoS descriptor. The MMT package may correspond to a program of the MPEG-2 TS.

The delivery layer may perform network flow multiplexing, network packetization, QoS control, and the like, of media transmitted through, for example, a network.

The delivery layer (D-layer) may be configured of an MMT D.1 layer, an MMT D.2 layer, and an MMT D.3 layer, as shown in FIG. 1.

The D.1-layer receives the MMT package generated in the E.1 layer to generate an MMT payload format. The MMT payload format is a payload format for transmitting the MMT asset and transmitting information for consumption by an MMT application protocol or other existing application transport protocols such as RTP. The MMT payload may include the fragment of the MFU together with information such as AL-FEC.

The D.2-layer receives the MMT payload format generated in the D.1 layer to generate the MMT transport packet or the MMT packet. The MMT transport packet or the MMT packet is a data format used for the application transport protocol for the MMT.

The D.3-layer provides a function of exchanging information between layers by a cross-layer design to support the QoS. For example, the D.3-layer may use a QoS parameter of an MAC/PHY layer to perform the QoS control.

The S layer performs a signaling function. For example, the S layer may perform signaling functions such as session initialization/control/management, server based and/or client based trick mode, service discovery, synchronization, and the like, of the transmitted media.

The S layer may be configured of an MMT S.1 layer and an MMT S.2 layer as shown in FIG. 1.

The S.1 layer may perform service discovery, media session initialization/termination, media session presentation/control, an interface function between the delivery (D) layer and the encapsulation (E) layer, and the like. The S.1 layer may define a format of control messages between applications for media presentation session management.

The S.2 layer may define the format of the control message exchanged between delivery end-points of the delivery layer (D-layer) regarding flow control, delivery session management, delivery session monitoring, error control, and hybrid network synchronization control.

The S.2 layer may include delivery session establishment and release, delivery session monitoring, flow control, error control, resource reservation for established delivery session, signaling for synchronization under the hybrid delivery environment, and signaling for adaptive delivery, so as to support the operation of the delivery layer. It is possible to provide required signaling between a sender and a receiver. That is, the S.2 layer may provide the required signaling between the sender and the receiver so as to support an operation the delivery layer as described above. In addition, the S.2 layer may perform the interface function between the delivery layer and the encapsulation layer.

The exemplary embodiment of the present invention relates to an apparatus and a method for transmitting and receiving media data capable of obtaining playout time information on media in the MMT system and including the D-layer timing information for playing media while maintaining temporal synchronization between the media. The exemplary embodiment of the present invention may record the important time information generated during a process of generating an MMT packet to be transmitted in a system for transmitting an MMT in the D-layer of the MMT and may transmit the recorded time information to the receiving terminal. The apparatus for receiving media data may play media while maintaining the accurate temporal synchronization between the media based on the D-layer temporal information. To this end, the apparatus for transmitting media data may be recorded the important time information that can be secured at time when a D-layer header is generated at the time of generating the MMT packet in the D-layer header.

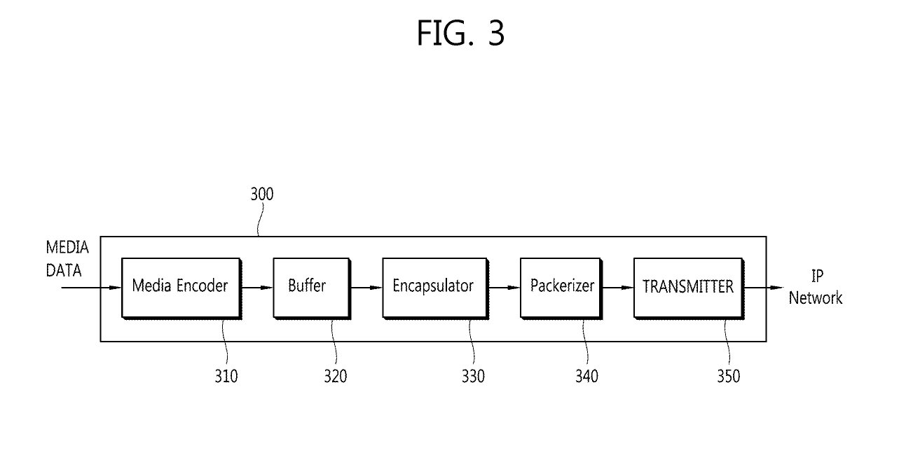

FIG. 3 is a block diagram showing a configuration of an apparatus for transmitting media data according to an exemplary embodiment of the present invention. As shown in FIG. 3, an apparatus 300 for transmitting media data according to an exemplary embodiment of the present invention may include an encoder 310 encoding media data to generate a media stream, a buffer 320 storing the encoded media stream, an encapsulator 330 encapsulating the encoded media stream to generate encapsulation layer data (E-layer data), a packetizer 340 packetize the E-layer data to generate a delivery layer packet (D-layer packet) including timing information, and a transmitter 350 transmitting the packetized D-layer packet. In this configuration, the timing information included in the D-layer data includes sampling time information and sender processing delay information.

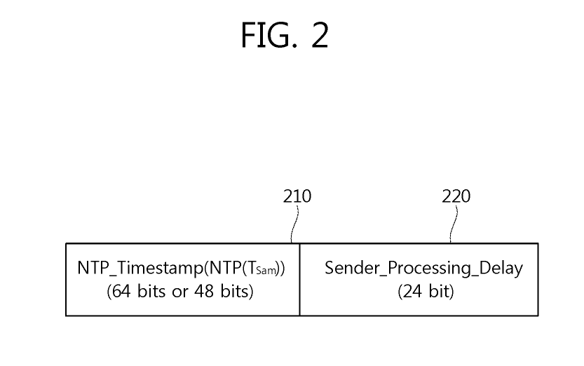

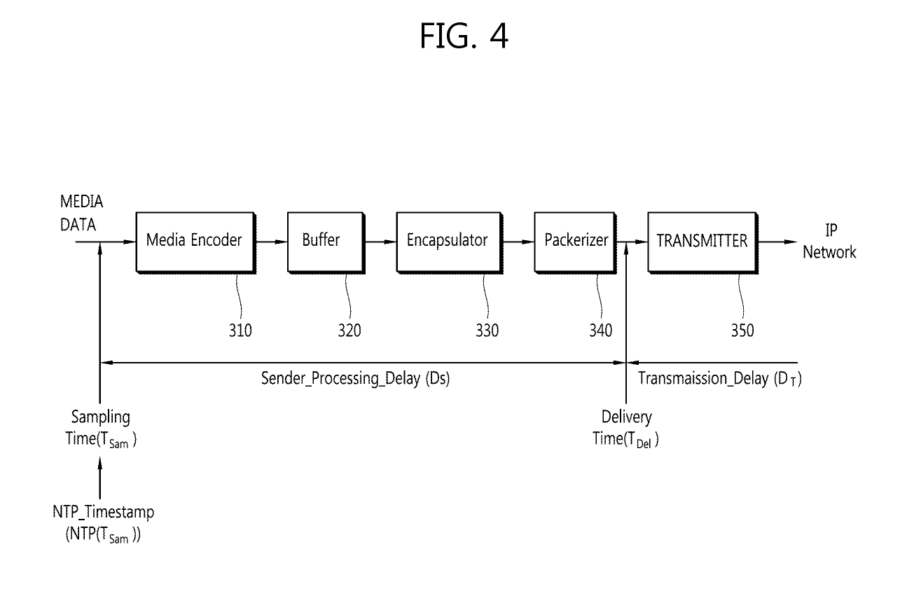

FIG. 2 is a diagrams showing basic timing information that is recorded in a D-layer header of an MMT. In addition, FIG. 4 is a diagram showing main time information that needs to be considered to maintain accurate synchronization between media in the apparatus for transmitting media data. Hereinafter, the timing model for maintaining synchronization in the apparatus for transmitting media data using the sampling time information and the sender processing delay information included in the timing information will be describe in detail with reference to FIGS. 2 and 4.

As shown in FIG. 2, the timing information recorded in the header of the D-layer data of the MMT may include sampling time information (hereinafter, referred to as ‘NTP (T_{Sam})’) 210 and sender procedure delay information 220 (hereinafter, referred to as ‘Sender processing delay’) 220. The timing information may be generated in the E-layer of the MMT so as to be allocated to the MMT package carried on the payload of the MMT packet. Here, the sampling time information is a network time protocol (NTP) time stamp format and includes a seconds part and a seconds fraction part, wherein the integer part may have a size corresponding to any one of 32 bits or 16 bits. Further, the sender procedure delay information includes delay time information up to time when the D-layer packet is generated and the transmission thereof starts after the sampling time according to the sampling time information.

Describing in more detail with reference to FIG. 4, the sampling time information (T_{Sam}) 210 may include the sampling time for pictures input to a media encoder 310 in the compressed order. The NTP (T_{Sam}) 210 represents universal time coordinated (UTC) time corresponding to the NTP (T_{Sam}) 210 that is the sampling time of the media frame input to the encoder 310 of the MMT as an NTP timestamp format. A method for representing the NTP (T_{Sam}) 210 as the NTP timestamp format may be implemented in two types.

Basically, the NTP timestamp format may be configured of a total of 64 bits. A length of 64 bits may include a seconds part that represents second time in an integer precision unit as a length of 32 bits and a seconds fraction part that represents second time in a fraction precision unit as a length of 32 bits. In the case of the seconds part representing the integer precision, when the overall length of 32 bits is used, the UTC time corresponding to 136 years after Jan. 1, 1900 may be represented. However, it is sufficient if the time interval used for media synchronization for the MMT system based media service is within several days. Therefore, if the service is completed within 18 hours after the service starts, it is enough to use only the lower 16 bits without using the overall interval of 32 bits. Meanwhile, in order to maximize the precision of the time synchronization, the second time in the fraction precision unit may use the overall 32 bits according to an original format.

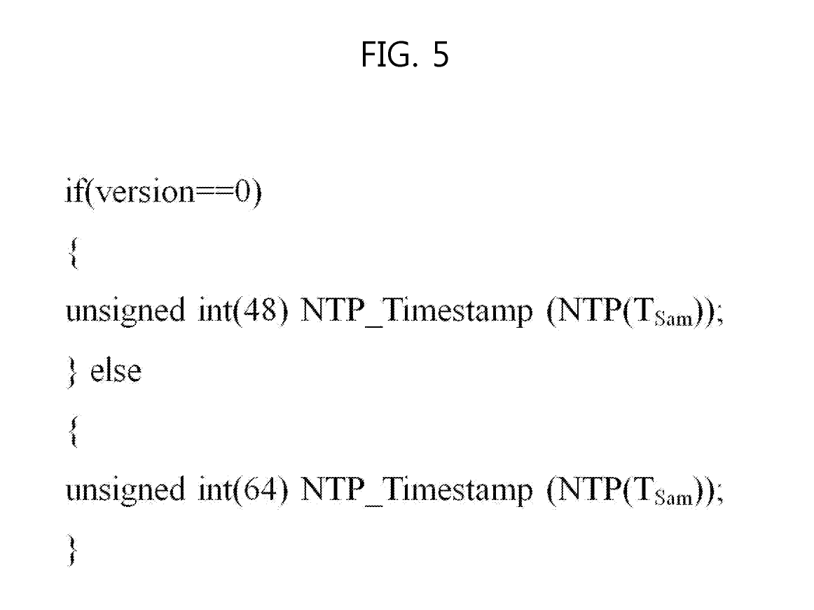

FIG. 5 is a diagram showing a method for selecting a length of a seconds part of sampling timing information of FIG. 2 As shown in FIG. 5, in the apparatus 300 for receiving media data according to an exemplary embodiment of the present invention a method for representing the NTP timestamp for the NTP (T_{Sam}) 210 may select one of (16 bits (seconds part)+32 bits (seconds fraction part)=48 bits) and (32 bits (seconds part)+32 bits (seconds fraction part)=64 bits) for each version with reference to the method as shown in FIG. 5. That is, the seconds part may have a size corresponding to any one of 32 bits and 16 bits.

The sender processing delay (DS) 220 may represent the delay time consumed for processing in the apparatus 300 for transmitting media data up to delivery time (T_{Del}) that is time when the D-layer packet is generated and the transmission thereof starts after the sampling time.

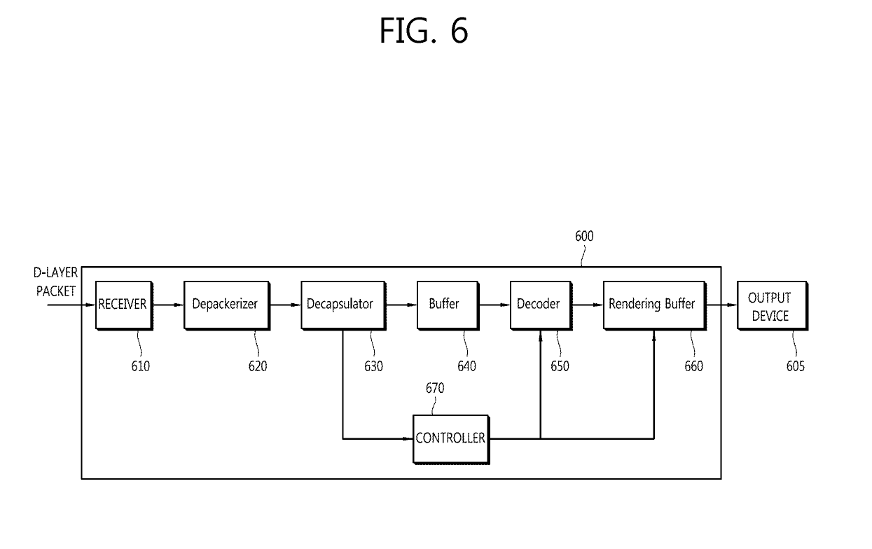

FIG. 6 is a block diagram showing a configuration of an apparatus for receiving media data according to an exemplary embodiment of the present invention.

As shown in FIG. 6, an apparatus 600 for receiving media data according to an exemplary embodiment of the present invention may include a receiver 610 receiving a delivery layer packet (D-layer packet), a depacketizer 620 depacketizing the D-layer packet to generate the encapsulation layer data (E-layer data) and extract the timing information, a decapsulator 630 decapsulating the E-layer data to generate the encoded media stream, a buffer 640 storing the encoded media stream, a decoder 650 decoding the encoded media stream, and a rendering buffer 660 realigning the decoded media data for display.

Here, the timing information may include the sampling time information and the sender processing delay. The timing information is the same as the timing information of the foregoing apparatus for transmitting media data. That is, the D-layer timing information may include two fields such as the sampling time information NTP (T_{Sam}) 210, the sender processing delay 220, and the like.

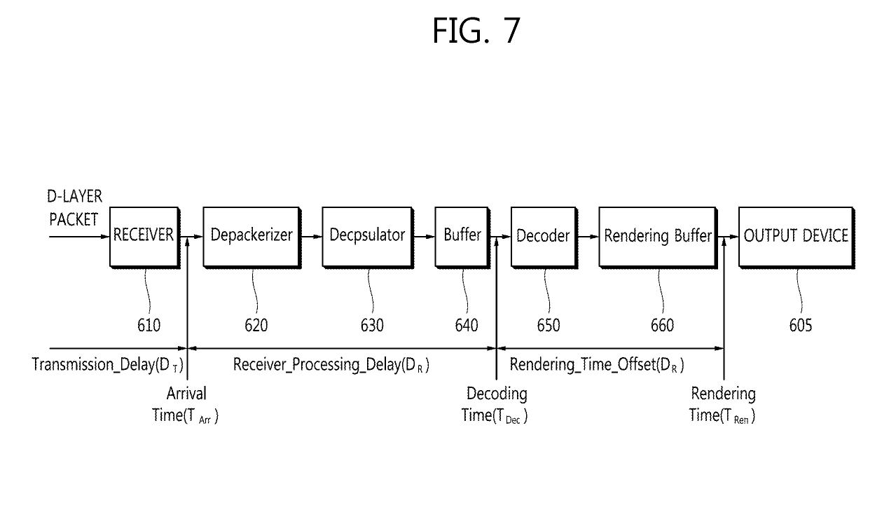

FIG. 7 is a diagram showing main time information that needs to be considered to maintain accurate synchronization between media in the apparatus for receiving media data. The apparatus 600 for receiving media data according to the exemplary embodiment of the present invention will be described in more detail with reference to FIGS. 6 and 7.

In the apparatus 300 for transmitting media data, the transmitted MMT D-layer packet at the delivery time (T_{Del}) may be input to the D-layer depacketizer 620 of the apparatus 600 for receiving media data at arrival time (T_{Arr}) after transmission delay (D_{T}) via a transmitter 350, a transmission channel (not shown), and a receiver 610. Continuously, the MMT D-layer packet is input to a decoder 650 after receiver_processing_delay (DS) that is the delay time consumed via the depacketizer 620, the E-layer decapsulator 630, and the buffer 640 and may start to be decoded at decoding time (T_{Dec}).

The MMT D-layer packet is decoded and stays in the rendering buffer 660 as much as rendering_time_offset (D_{O}), and is played by an output device 605 at rendering time (T_{Ren}). The timing information such as the delivery time (T_{Del}), the arrival time (T_{Arr}), the decoding time (T_{Dec}), and the like, that are shown in FIGS. 4 and 7 is represented based on the sampling time (T_{Sam}), which is represented by the following Equation 1.

T_{Del}=T_{Sam}+D_{S}

T_{Arr}T_{Sam}+D_{S}+D_{T}

T_{Dec}=T_{Sam}+D_{S}+D_{T}D_{R} [Equation 1]

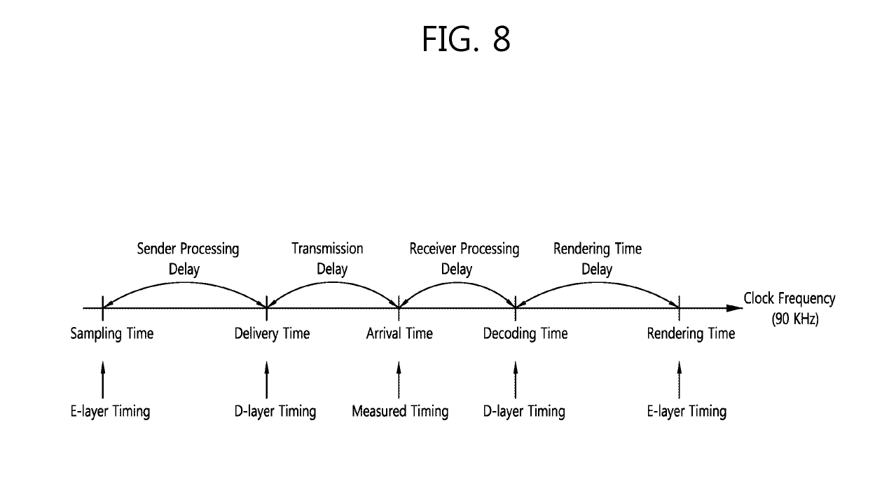

FIG. 8 is a diagram showing temporal correlation between the timing information used in the exemplary embodiment of the present invention. The temporal correlation between the main timing information that needs to be considered in the E-layer and the D-layer of the MMT system will be described with reference to FIG. 8.

The timing information shown in FIG. 8 may be represented by a sampling clock frequency operated at precision of 90 KHz that is generally used in the MPEG-2 system and the RTP transport system. Among the timing information, the sampling time and the rendering time are information that may be provided in the E-layer of the MMT and the delivery time and the decoding time can be induced based on the timing information that can be provided in the D-layer. The arrival time may be actually measured by using the UTC time in the apparatus for receiving media data. When the measured arrival time and the UTC time information corresponding to the delivery time provided in the D-layer are used, the transmission delay value can be accurately calculated.

Hereinafter, a method for allowing the apparatus 600 for receiving media data according to the exemplary embodiment of the present invention using the timing information shown in FIGS. 4, 7, and 8 to achieve accurate media synchronization will be described.

In order to seamlessly provide the media service while performing the synchronization between the MMT system based end-to-end terminals (that is, between the apparatus for transmitting media data and the apparatus for receiving media data), a total sum of the Sender processing delay (DS), the transmission delay (D_{T}), and the Receiver processing delay (D_{R}) needs to be maintained as a constant value of D_{Tot} as represented by the following Equation 2.

D_{S}+D_{T}=D_{R}=D_{Tot} [Equation 2]

In the above Equation 2, the D_{S} is the delay time that is generated in advance during the process of processing the apparatus 300 for transmitting media data, the D_{T} is the delay time that is generated in advance during the transmitting process through the network, such that the apparatus 600 for receiving media data may appropriately control the D_{R} value to constantly maintain the D_{Tot}.

A size of the D_{Tot} parameter may be determined as an appropriate value in consideration of the service delay time experienced by a consumer. The D_{Tot} parameter is transmitted from the server to the apparatus 600 for receiving media data based on the signaling procedure by the S-layer of the MMT at the initial step of the media service and therefore, is previously known by the apparatus 600 for receiving media data before the media transmission service is performed in earnest.

The apparatus 300 for transmitting media data may record the NTP (T_{Sam}) 210 and D_{S} 220 values as shown in FIG. 2 in the D-layer header of the MMT packet to transmit the MMT D-layer packet. Here, as shown in FIG. 6, the apparatus 600 for receiving media data may further include a controller 670 determining the delivery time that represents time when the apparatus 300 for transmitting media data generates the D-layer packet based on the NTP (T_{Sam}) 210 and the D_{S} 220 and starts to transmit the generated D-layer packet. That is, in the apparatus 600 for receiving media data that receives the MMT D-layer packet, the controller 670 may calculate the time value represented by the NTP formation of the UTC time corresponding to the delivery time (T_{Del}) based on the following Equation 3.

NTP(T_{Del})=NTP(T_{Sam})+D_{S}/90,000 [Equation 3]

In the above Equation 3, it is assumed that the sampling clock frequency operated at the precision of 90 KHz generally used in the MPEG-2 system and the RTP transport system is used. Even when the sampling clock frequency having precision in addition to the precision of 90 KHz is adopted, the same principle can be applied.

The transmission delay (D_{T}) means the lapsed time between the delivery time (T_{Del}) of FIG. 4 and the arrival time (T_{Arr}) of FIG. 7. The arrival time (T_{Arr}) may be measured after the MMT D-layer packet arrives at the receiver 610 and the UTC time corresponding to the time may be represented by the NTP (T_{Arr}) that is the NTP format.

Here, the controller 670 measures the arrival time representing the time when the D-layer packet arrives at the apparatus 600 for receiving media data and may additionally determine the transmission delay based on the arrival time and the transmission time. That is, the controller 670 of the apparatus 600 for receiving media data uses the measured NTP (T_{Arr}) and the NTP (T_{Del}) value calculated in Equation 3 to calculate the transmission delay (D_{T}) based on the following Equation 4.

D_{T}=(NTP(T_{Arr})−NTP(T_{Del}))+90,000 [Equation 4]

Here, the controller 670 may determine the receiver processing delay (D_{R}) based on the sender processing delay (DS) and the transmission delay (D_{T}) that are included in the sender processing delay so as to constantly maintain a total of delay time (D_{Tot}). That is, the D_{R} value satisfying the Equation 2 from the D_{S} value that is recorded in the MMT D-layer packet and delivered and the D_{T} value obtained by the above Equation 4 may be determined based on the following Equation 5.

D_{R}=D_{Tot}−(D_{S}+D_{T}) [Equation 5]

The controller 670 of the apparatus 600 for receiving media data may use the D_{R} value to derive the accurate time that stays in the buffer 640 before the compressed frame data are decoded and may thus process the MMT data while accurately satisfying the decoding time (T_{Dec}). The decompressed frame data obtained after the decoding is performed at T_{Dec} may be played by the output device 605 at the rendering time (T_{Ren}) after staying in the rendering buffer 660 as much as the rendering_time_offset (D_{O}).

Meanwhile, the above proposed method may simply match the synchronization between the multiple media streams transmitted from the same server and the synchronization between the multiple media data transmitted from different servers (that is, the apparatus for transmitting media data). That is, the controller 670 may use the sampling time information and the sender processing delay so as to adjust the synchronization of the media data received from different apparatuses for transmitting media data For example, when a left view and a right view of a multi-view video are transmitted to a specific terminal via different servers, the receiving terminal processes the left view and the right view received through different paths while synchronizing the left and right views. When performing the processing according to the described exemplary embodiment of the present invention, the smooth synchronization can be implemented.

As another example, even when the video stream and the audio stream may be transmitted from different servers to the specific terminal, lip-synchronization between the video stream and the audio stream may be simply performed by the described embodiment of the present invention. Therefore, the described exemplar embodiment of the present invention may be very effectively used to provide the synchronization under the hybrid delivery environment in which the multiple media are transmitted live through various channel paths.

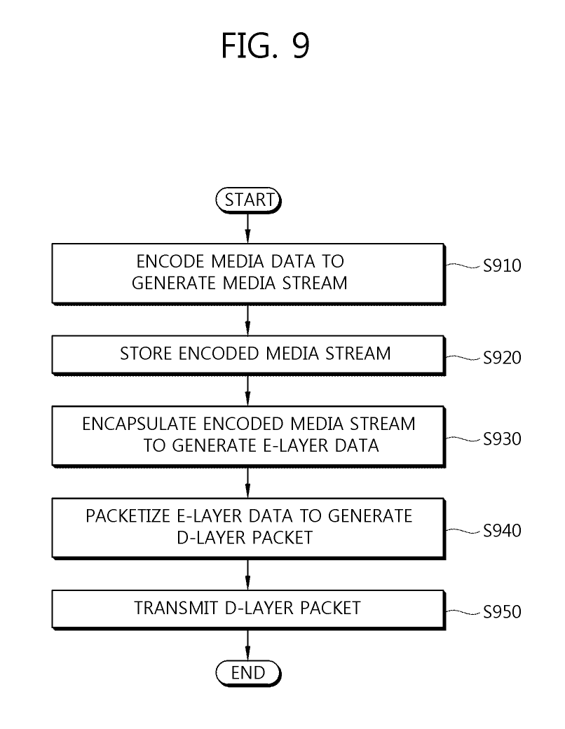

FIG. 9 is a flow chart of a method for transmitting media data according to an exemplary embodiment of the present invention.

As shown in FIG. 9, a method for transmitting media data according to an exemplary embodiment of the present invention may include encoding media data to generate a media stream (S910), storing the encoded media stream (S920), encapsulating the encoded media stream to generate encapsulation layer data (E-layer data) (S930), packetizing the E-layer data to generate a delivery layer packet (D-layer packet) including the timing information (S940), and transmitting the packetized D-layer packet (S950). Here, the timing information may include the sampling time information and the sender processing delay.

Here, the sampling time information is a network time protocol (NTP) time stamp format and includes a seconds part and a seconds fraction part, wherein the integer part may have a size corresponding to any one of 32 bits or 16 bits. Further, the sender procedure delay information includes delay time information up to time when the D-layer packet is generated and the transmission thereof starts after the sampling time according to the sampling time information.

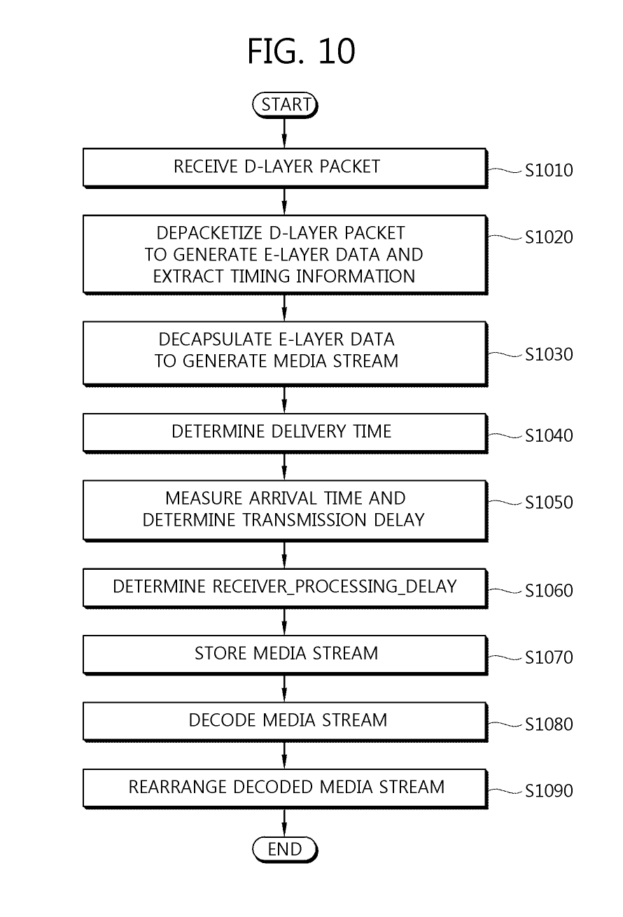

FIG. 10 is a flow chart of a method for receiving media data according to an exemplary embodiment of the present invention.

As shown in FIG. 10, the method for receiving media data according to the exemplary embodiment of the present invention first receives the delivery layer packet (D-layer packet) (S1010). Further, the D-layer packet may be depacketized to generate the encapsulation layer data (E-layer data) and the extract the timing information (S1020). Here, the timing information may include the sampling time information and the sender processing delay. Next, the encoded media stream may be generated by decapsulating the E-layer data (S1030).

When the extraction of the timing information completes, the delivery time representing the time when the apparatus for transmitting media data generates the D-layer packet based on the sampling time information and the sender-processing-delay included in the timing information and starts to transmit the generated D-layer packet may be determined (S1040). In addition, the arrival time representing the time when the D-layer packet arrives at the apparatus for receiving media data may be measured and the transmission delay may be determined based on the arrival time and the transmission time (S1050). Thereafter, the receiver processing delay may be determined based on the sender processing delay time and the receiver processing delay included in the sender processing delay (S1060) so as to constantly maintain a total of delay time.

Next, the encoded media stream may be stored (S1070), the encoded media stream may be decoded (S1080), and the decoded media data may be realigned for display (S1090).

According to the apparatus and method for transmitting media data and the apparatus and method for receiving media data according to the exemplary embodiment of the present invention, it is possible to provide the playout time of the media in the MMT system based media transport service and the timing information for temporal synchronization between the media. The D-layer timing information of the MMT proposed by the exemplary embodiment of the present invention is used together with the sampling time representing the encoder input time of the media frame provided in the E-layer and the rendering time representing the playout time of the media frame to implement the service while maintaining the accurate temporal synchronization between the media at the receiving terminal.

While the present invention has been shown and described in connection with the embodiments, it will be apparent to those skilled in the art that modifications and variations can be made without departing from the spirit and scope of the invention as defined by the appended claims.

What is claimed is:

1. An apparatus for transmitting media data, comprising:
a packetizer packetizing an encapsulation layer data (E-layer data) to generate a delivery layer packet (D-layer packet) including timing information,
wherein the timing information is used for temporal synchronization between the media data.

2. The apparatus of claim 1, wherein the timing information includes sampling time information and sender processing delay.

3. The apparatus of claim 1, further comprising:
an encoder encoding the media data to generate a media stream;
a buffer storing the encoded media stream;
an encapsulator encapsulating the encoded media stream to generate the E-layer data; and
a transmitter transmitting the packetized D-layer packet.

4. The apparatus of claim 2, wherein the sampling time information is a network time protocol (NTP) time stamp format and includes a seconds part and a seconds fraction part, and
the seconds part has a size corresponding to any one of 32 bits and 16 bits.

5. The apparatus of claim 2, wherein the sender processing delay includes delay time information up to time when the D-layer packet is generated and the transmission thereof starts after the sampling time according to the sampling time information.

6. An apparatus for receiving media data, comprising:
a depacketizer depacketizing a delivery layer packet (D-layer packet) to generate an encapsulation layer data (E-layer data) and extract timing information,
wherein the timing information is used for temporal synchronization between the media data.

7. The apparatus of claim 6, wherein the timing information includes sampling time information and sender processing delay.

8. The apparatus of claim 6, further comprising:
a receiver receiving a delivery layer packet (D-layer packet);
a decapsulator decapsulating the E-layer data to generate an encoded media stream;
a buffer storing the encoded media stream;
a decoder decoding the encoded media stream; and
a rendering buffer realigning the decoded media data for display.

9. The apparatus of claim 7, further comprising:
a controller determining delivery time representing time when the apparatus for transmitting media data generates a D-layer packet based on the sampling time information and the sender processing delay and starts to transmit the generated D-layer packet.

10. The apparatus of claim 9, wherein the controller measures arrival time representing the time when the D-layer packet arrives at the apparatus for receiving media data and additionally determines transmission delay based on the arrival time and the transmission time.

11. The apparatus of claim 10, wherein the controller determines receiver processing delay based on the sender processing delay and the receiver processing delay included in the sender processing delay so as to constantly maintain a total of delay time.

12. A method for transmitting media data, comprising:
packetizing an encapsulation layer data (E-layer data) to generate a delivery layer packet (D-layer packet) including timing information,
wherein the timing information is used for temporal synchronization between the media data.

13. The method of claim 12, wherein the timing information includes sampling time information and sender processing delay.

14. The method of claim 12, further comprising:
encoding the media data to generate a media stream;
storing the encoded media stream;
encapsulating the encoded media stream to generate the E-layer data; and
transmitting the packetized D-layer packet.

15. The method of claim 13, wherein the sampling time information is a network time protocol (NTP) time stamp format and includes a seconds part and a seconds fraction part, and
the seconds part has a size corresponding to any one of 32 bits and 16 bits.

16. The method of claim 13, wherein the sender processing delay includes delay time information up to time when the D-layer packet is generated and the transmission thereof starts after sampling time according to the sampling time information.

17. A method for receiving media data, comprising:
depacketizing a delivery layer packet (D-layer packet) to generate an encapsulation layer data (E-layer data) and extract timing information,
wherein the timing information is used for temporal synchronization between the media data.

18. The method of claim 17, wherein the timing information includes sampling time information and sender processing delay.

19. The method of claim 17, further comprising:
receiving the delivery layer packet (D-layer packet);
decapsulating the E-layer data to generate an encoded media stream;
storing the encoded media stream;
decoding the encoded media stream; and
realigning the decoded media data for display.

20. The method of claim 18, further comprising:
determining delivery time representing time when the apparatus for transmitting media data generates a D-layer packet based on the sampling time information and the sender processing delay and starts to transmit the generated D-layer packet.

21. The method of claim 20, further comprising:
measuring arrival time representing the time when the D-layer packet arrives at the apparatus for receiving media data and additionally determining transmission delay based on the arrival time and the transmission time.

22. The method of claim 21, further comprising:
determining receiver processing delay based on the sender processing delay and the receiver processing delay included in the sender processing delay so as to constantly maintain a total of delay time.
